(19) United States
(12) Patent Application Publication
(10) Pub. No.: US 2026/0004373 A1
(43) Pub. Date: Jan. 1, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Kazushi MIYAGI, Tokyo (JP); Seiichi YAMAMOTO, Tokyo (JP); Shinnosuke NISHIMOTO, Tokyo (JP)

(73) Assignee: NEC Corporation, Tokyo (JP)

(21) Appl. No.: 19/235,914

(22) Filed: Jun. 12, 2025

(30) Foreign Application Priority Data
Jun. 28, 2024 (JP) 2024-104644

(51) Int. Cl. G06Q 50/20; G06F 40/35; G06Q 10/0639

(52) U.S. Cl. CPC G06Q 50/2057; G06Q 10/06398; G06F 40/35

(57) ABSTRACT

An object is to properly evaluate a training. An information processing apparatus includes a collecting unit configured to collect a work log related to a work activity performed by an employee, a determination unit configured to determine a relevance level between the work log and a training participated in by the employee, a transmitting unit configured to transmit a question for evaluating the training to the employee based on a comparison of the relevance level with a threshold, and a receiving unit configured to receive answer data of the employee to the question.

### INCORPORATION BY REFERENCE

This application is based upon and claims the benefit of priority from Japanese patent application No. 2024-104644, filed on Jun. 28, 2024, the disclosure of which is incorporated herein in its entirety by reference.

### TECHNICAL FIELD

The present disclosure relates to an information processing apparatus, an information processing method, and a program.

### BACKGROUND ART

Patent Literature 1 discloses that information indicating the states of participants in a lecture or the like is automatically collected and provided to a lecturer. In Patent Literature 1, face information of participants are extracted from a plurality of images, and participants in a predetermined participating state such as “nodding” or “dozing” are identified based on the extracted face information. Then, an evaluation for the lecture is output only for time periods during which it is detected that the number of participants in the predetermined participating state exceeds a predetermined number.
Patent Literature 1: Japanese Unexamined Patent Application Publication No. 2007-102344

### SUMMARY

In the technology disclosed in Patent Literature 1, there is a problem that it is impossible to, for example, properly evaluate a training (e.g., a lecture or a seminar) in some cases.

In view of the above-described problem, an object of the present disclosure is to provide a technology for properly evaluating a training (e.g., a lecture or a seminar).

In a first aspect, the present disclosure provides an information processing apparatus including: a collecting unit configured to collect a work log related to a work activity performed by an employee; a determination unit configured to determine a relevance level between the work log and a training that the employee has participated; a transmitting unit configured to transmit a question for evaluating the training to the employee in a case where the relevance level is equal to or higher than a threshold; and receiving unit configured to receive answer data of the employee to the question.

Further, in a second aspect, the present disclosure provides an information processing method, in which an information processing apparatus: collects a work log related to a work activity performed by an employee; determines a relevance level between the work log and a training that the employee has participated; transmits a question for evaluating the training to the employee in a case where the relevance level is equal to or higher than a threshold; and receives answer data of the employee to the question.

Further, in a third aspect, the present disclosure provides a program for causing a computer to: collect a work log related to a work activity performed by an employee; determine a relevance level between the work log and a training that the employee has participated; transmit a question for evaluating the training to the employee in a case where the relevance level is equal to or higher than a threshold; and receive answer data of the employee to the question.

According to an aspect, a training can be properly evaluated.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows an example of a configuration of an information processing apparatus according to an example embodiment;

FIG. 2 shows an example of a configuration of an information processing system according to an example embodiment;

FIG. 3 shows an example of a hardware configuration of an information processing apparatus according to an example embodiment;

FIG. 4 is a flowchart showing an example of processes performed by an information processing apparatus according to an example embodiment;

FIG. 5 shows an example of information stored in an employee DB (DataBase) according to an example embodiment; and

FIG. 6 shows an example of information stored in a training evaluation DB according to an example embodiment.

### EXAMPLE EMBODIMENT

The principle of the present disclosure will be described with reference to several example embodiments. It should be understood that these embodiments are described only for an illustrative purpose and will assist those skilled in the art in understanding and carrying out the present disclosure without suggesting any limitations in regard to the scope of the disclosure. Disclosures described in this specification can also be implemented in a variety of ways other than those described below.

In the following description and the claims, unless otherwise defined, all technical and scientific terms used in this specification have the same meanings as those generally understood by those skilled in the technical field to which the present disclosure belongs.

An example embodiment according to the present disclosure will be described hereinafter with reference to the drawings. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### <Configuration>

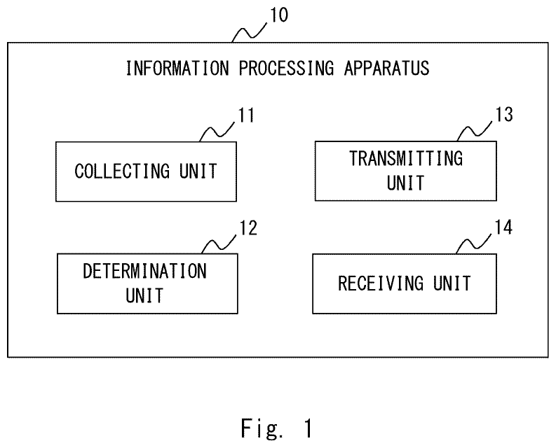

A configuration of an information processing apparatus 10 according to an example embodiment will be described with reference to FIG. 1. FIG. 1 shows an example of the configuration of the information processing apparatus 10 according to the example embodiment. The information processing apparatus 10 includes a collecting unit 11, a determination unit 12, a transmitting unit 13, and a receiving unit 14. Each of these units may be implemented by cooperation between at least one program installed in the information processing apparatus 10 and hardware such as a processor and a memory of the information processing apparatus 10.

The collecting unit 11 collects work logs relevant to work activities performed by employees. The determination unit 12 determines a relevance level between the work log collected by the collecting unit 11 and a training (e.g., a lecture or a seminar) that an employee has participated.

In a case where the relevance level determined by the determination unit 12 is equal to or higher than a threshold, the transmitting unit 13 transmits a question for evaluating the training to the employee. The receiving unit 14 receives answer data of the employee to the question transmitted by the transmitting unit 13. In this way, for example, the training can be properly evaluated.

### Second Example Embodiment

### <System Configuration>

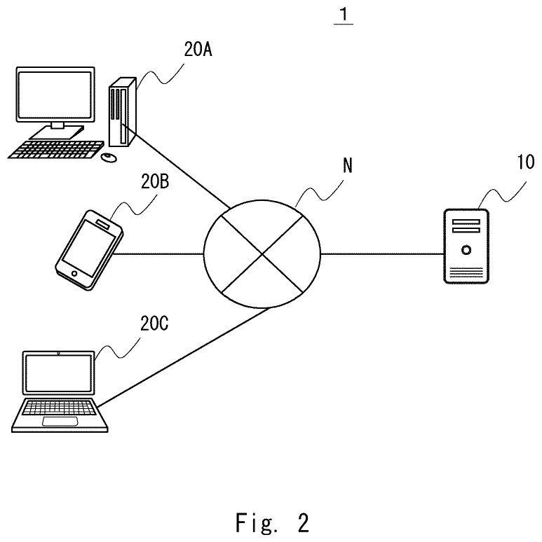

Next, a configuration of an information processing system 1 according to an example embodiment will be described with reference to FIG. 2. FIG. 2 shows an example of the configuration of the information processing system 1 according to the example embodiment. In the example shown in FIG. 2, the information processing system 1 includes an information processing apparatus 10 and employee terminals 20A to 20C. Hereinafter, in a case where it is unnecessary to distinguish the employee terminals 20A to 20C from one another, they are simply referred to as “employee terminals 20”.

In the example shown in FIG. 2, the information processing apparatus 10 and the employee terminals 20 are connected to each other through a network N so that they can communicate with each other. Note that the number of the information processing apparatus 10 and the employee terminals 20 is not limited to the number in the example shown in FIG. 2.

Examples of the network N include the Internet, a mobile communication system, a wireless LAN (Local Area Network), a LAN, and a bus. Examples of the mobile communication system include the 5th generation mobile communication system (5G), the 6th generation mobile communication system (6G, Beyond 5G), the 4th generation mobile communication system (4G), and the 3rd generation mobile communication system (3G).

The information processing apparatus 10 is, for example, a server, a cloud server, a personal computer, a smartphone, or the like. The information processing apparatus 10 determines, for example, a relevance level between actual work activities performed by an employee and a training (e.g., a lecture or a seminar).

The employee terminals 20 is, for example, a terminal, such as a personal computer (PC), a smartphone, a tablet computer, or a wearable apparatus, which the employee uses in his/her work activities.

### <Hardware Configuration>

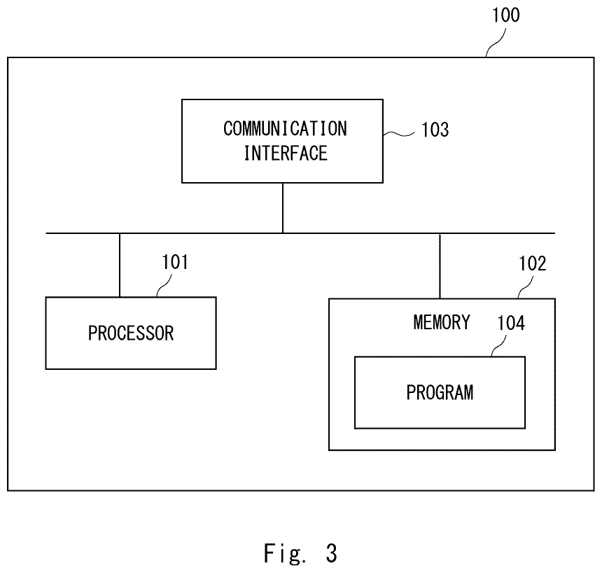

FIG. 3 shows an example of a hardware configuration of the information processing apparatus 10 according to the example embodiment. In the example shown in FIG. 3, the information processing apparatus 10 (computer 100) includes a processor 101, a memory 102, and a communication interface 103. These components may be connected with each other by a bus or the like. The memory 102 stores at least a part of the program 104 (or some of the programs 104). The communication interface 103 includes an interface necessary for communication with other network elements.

In a case where the program 104 is executed through the cooperation of the processor 101, the memory 102, and the like, at least one of the processes of the example embodiment according to the present disclosure is performed by the computer 100. Any type of memory may be used as the memory 102. The memory 102 may be, but is not limited to, a non-transitory computer readable storage medium. Further, the memory 102 may be implemented by using any suitable data storage technology such as a semiconductor-based memory device, a magnetic memory device and system, an optical memory device and system, a fixed memory, and a removable memory. Although only one memory 102 is provided in the computer 100, a plurality of physically different memory modules may be provided in the computer 100. The processor 101 may be of any type. The processor 101 may include at least one of a general-purpose computer, a dedicated computer, a microprocessor, a digital signal processor (DSP: Digital Signal Processor), and, as a non-limiting example, a processor based on a multi-core processor architecture. The computer 100 may include a plurality of processors, such as an application-specific integrated circuit chip that is temporally dependent on a clock for synchronizing the main processor.

An example embodiment according to the present disclosure may be implemented by hardware, a dedicated circuit, software, a logic, or any combination thereof. In some aspects, an example embodiment may be implemented by hardware, while in other aspects, an example embodiment may be implemented by firmware or software that may be executed by a controller, a microprocessor, or other computing devices.

The present disclosure also provides at least one computer program product that is tangibly stored in a non-transitory computer readable storage medium. The computer program product contains computer executable instructions, such as those contained in program modules, and is executed by a target real processor or by a device on a virtual processor, so that a process(es) or a method according to the present disclosure is performed. The program module contains routines, programs, libraries, objects, classes, components, and data structures for performing specific tasks or implementing specific abstract data types. The functions of the program module may be combined with those of the other program modules, or divided into a plurality of program modules as desired in various example embodiments. The machine executable instructions in the program module can be executed locally or in a distributed device(s). In the distributed device, the program module can be disposed on both local and remote storage media.

The program codes for performing the method according to the present disclosure may be written in any combination of at least one programming language. These program codes are provided to a processor or a controller of a general-purpose computer, a dedicated computer, or other programmable data processors. These program codes are provided to a processor or a controller of a general-purpose computer, a dedicated computer, or other programmable data processing apparatuses, and in a case where such a program code is executed by the processor or the controller, a function/operation in a flowchart and/or a block diagram to be implemented is executed. The program code is entirely executed in a machine, partially executed in a machine as a standalone software package, partially executed in a machine, partially executed in a remote machine, or entirely executed in a remote machine or a server.

The program may be stored in various types of non-transitory computer readable media, and supplied to a computer. The non-transitory computer readable media includes various types of tangible storage media. Examples of non-transitory computer readable media include magnetic recording media, magneto-optical recording media, optical disk media, and semiconductor memory. Examples of magnetic recording media include flexible disks, magnetic tapes, and hard disk drives. Examples of magneto-optical recording media include magneto-optical disks. Examples of optical disk media include Blu-ray discs, CD (Compact Disc)-ROM (Read Only Memory), CD-R (Recordable), and CD-RW (ReWritable). Examples of semiconductor memories include solid-state drives, mask ROMs, PROMs (Programmable ROMs), EPROMs (Erasable PROMs), flash ROMs, and RAMs (random access memories). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### <Processing>

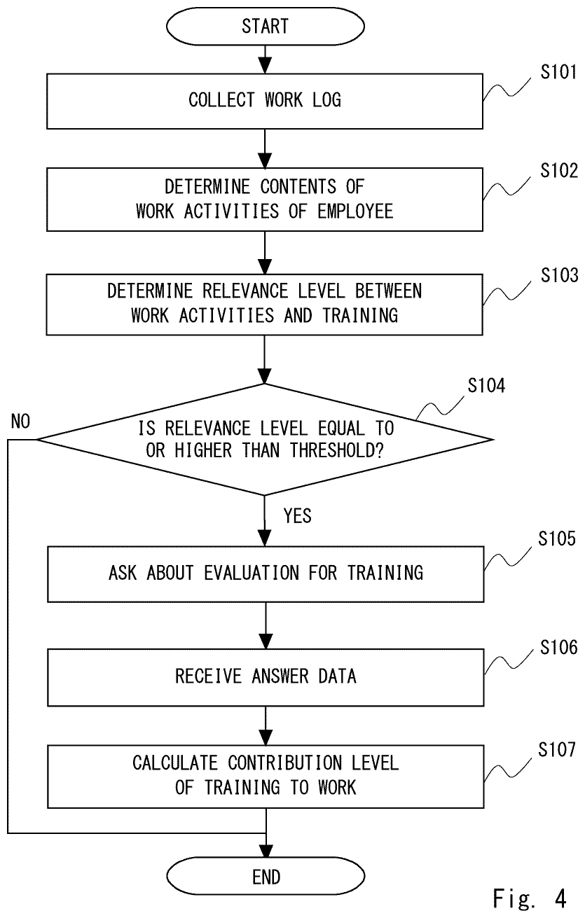

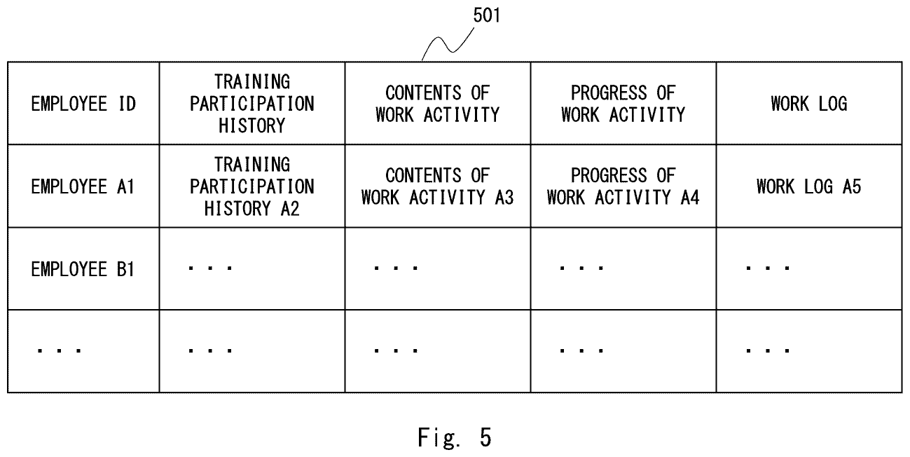

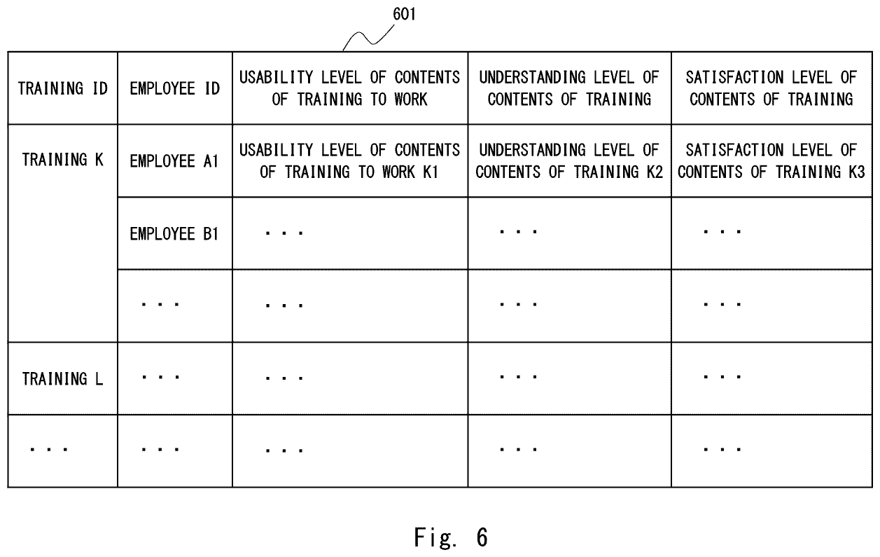

Next, an example of processes performed by the information processing apparatus 10 according to the example embodiment will be described with reference to FIGS. 4 to 6. FIG. 4 is a flowchart showing an example of processes performed by the information processing apparatus 10 according to the example embodiment. FIG. 5 shows an example of information stored in an employee DB (DataBase) 501 according to the example embodiment. FIG. 6 shows an example of information stored in a training evaluation DB 601 according to the example embodiment. Note that the series of processes shown in FIG. 4 may be performed, for example, at regular intervals.

In a step S101, the collecting unit 11 collects work logs relevant to work activities performed by employees. The work logs may include, for example, at least one of an operation log of an apparatus used by the employee in the work activities, the usage state of a meeting room by the employee, the progress of work performed by the employee registered in a work management system, a video image of work performed by the employee, contents of a document created by the employee, and data measured by a sensor.

Next, the determination unit 12 determines the contents (e.g., the type, the workload, and the like) of the work activities performed by the employee and the progress thereof based on the work logs collected by the collecting unit 11 (Step S102). Note that the determination unit 12 may determine the contents of the work activities and the progress thereof based on, for example, a video image of work performed by the employee by using an image recognition technology. Note that the video image of work may be taken by using a camera or a wearable device such as smart glasses.

Further, the determination unit 12 may analyze, for example, keywords and contexts in a document created by the employee based on the document by using a natural language processing technology, and thereby determine the contents of the work activities performed by the employee and the progress thereof. The document created by the employee may be, for example, a daily work report, a report, or an email.

Alternatively or additionally, the determination unit 12 may determine the contents of the work activities and the progress thereof based on, for example, data measured by a sensor(s). The sensor may be, for example, an IoT (Internet of Things) sensor attached to a machine or the like in a factory or a wearable sensor. Note that the type of the work log may be selected by the manager according to the contents (e.g., the type, the workload, and the like) of the work performed by the employee, the type of the job, the business type of the company, and the like.

The determination unit 12 may record the result of the determination in the employee DB 501. In the example shown in FIG. 5, in the employee DB 501, a training participation history, the contents of the work activities, the progress of the work activities, and the work log are recorded in association with an employee ID. The employee ID is identification information of the employee. The training participation history is a history of trainings that the employee participated in the past. The training participation history may include, for example, at least one combination of the training ID and the training completion date and time. The training participation history may be, for example, set (registered or recorded) in the employee DB 501 in advance by the manager or the like.

Next, the determination unit 12 determines a relevance level between the work activities performed by the employee and a training (e.g., a lecture or a seminar) that the employee has participated based on the work log collected by the collecting unit 11 (Step S103). Note that the determination unit 12 may calculate the relevance level based on, for example, at least one of a commonality level between keywords contained in the work log and keywords contained in a document of the training (hereinafter also referred to as a training document), and a similarity level therebetween.

In this case, the determination unit 12 may extract keywords contained in the work log, which is a document, and keywords contained in the work contents and the like determined based on the work log. Further, the determination unit 12 may extract, for example, keywords contained in the curriculums and materials, which are training documents. Then, the determination unit 12 may estimate a relevance level between the keywords based on the work log and the keywords contained in the training documents by using, for example, a natural language processing technology.

Further, the determination unit 12 may analyze each of the work log and the training document by using, for example, a topic analysis technique, and calculate the similarity level between their topic distributions as the relevance level. In this way, it is possible to quantitatively evaluate the overlapping of themes which are dealt with in the work and in the training. In this case, the determination unit 12 may use, for example, LSI (Latent Semantic Index), PLSI (Probabilistic Latent Semantic Indexing), or LDA (Latent Dirichlet Allocation) as the topic analysis technique.

Further, the determination unit 12 may convert each of the work log and the training document into a document vector by using, for example, a Doc2Vec technology, and calculate a distance on the vector space as the relevance level. Since the document vector contains information about semantic features of the document, it is possible to measure semantic closeness between the work and the training.

Alternatively or additionally, the determination unit 12 may determine (infer or estimate) the relevance level between the work log and the training document by using, for example, supervised learning. In this case, for example, a label indicating whether there is relevance or not may be manually assigned to each of a plurality of pairs each consisting of a work log and a training document. Then, the determination unit 12 may train a machine-trained model by using the labeled data as training data.

Further, the determination unit 12 may determine the relevance level between the work log and the training document by using, for example, a network analysis. In this case, the determination unit 12 may construct (generate or calculate) a network by using, for example, work logs and training contents as nodes and using strengths of relevance as edge weights. Then, the determination unit 12 may estimate, for example, the overall relevance between the work and the training based on the constructed network.

Further, the determination unit 12 may determine the relevance level between the work log and the training document by using, for example, a time-series analysis. In this case, the determination unit 12 may analyze, for example, a temporal context (a temporal order) between the work and the training based on time information of the work log and the participation completion date and time recorded in the training participation history. Then, for example, the determination unit 12 may determine the relevance level between the specific training and relevant work in such a manner that the more the efficiency (e.g., the progress level) of the relevant work after the training is improved, the more the relevance level is increased.

Next, the determination unit 12 determines whether or not the relevance level is equal to or higher than a threshold (Step S104). If the relevance level is lower than the threshold (Step S104: No), the series of processes is finished. On the other hand, if the relevance level is equal to or higher than the threshold (Step S104: Yes), the transmitting unit 13 transmits, to an employee(s) (employee terminal(s) 20) who has participated in one or more trainings whose relevance levels are determined to be equal to or higher than the threshold by the determination unit 12, a message including a question for evaluating each of the trainings (Step S105). This message may include, for example, a training ID and the question, or a URL (Uniform Resource Locator) of a Web site where the employee inputs his/her answer(s).

Note that in the above-described example, the case where the determination unit 12 determines a relevance level between a training document and a work log has been described. However, what is determined by the determination unit 12 according to the present disclosure is not limited to the training document, and any information related to a training may be used. For example, the determination unit 12 may determine a relevance level by also using video contents of the training or audio data thereof. In the case of video contents, the determination unit 12 may determine the relevance level by identifying a work procedure in the video image and/or an apparatus used therein by using a video analysis technology and analyzing similarity between them and information contained in the work log. In the case of voice data, the determination unit 12 may convert it into text by using a speech recognition technology and analyze the relevance between the text and the work log.

In this way, for example, after a marketing meeting in the work is finished, a notification for asking an employee(s) who has participated in the meeting about the evaluation of the marking training can be transmitted to the employee(s). This notification may include, for example, a questionnaire asking how useful the contents learned in the training was for the discussion and decision-making in the meeting. In this questionnaire, for example, the employee is made to answer, for each topic discussed in the training, how its knowledge and skills were used in the meeting in a specific manner. For example, it is assumed that an answer such as “We deepened our understanding about the customer segmentation technique and was able to use it to select the target customer” can be obtained.

Next, the receiving unit 14 receives answer data of the employee to the message transmitted by the transmitting unit 13 (Step S106). In this way, for example, it is possible to acquire an evaluation about the training that is highly relevant to the actual work, made by the employee. Therefore, for example, compared with the case where the employee is asked to answer a questionnaire about all the trainings, it is possible to reduce the time and effort that the employee needs to take to answer the questionnaire or the like. The receiving unit 14 may receive, for example, information indicating one of a plurality of trainings whose relevance levels are equal to or higher than the threshold, selected by the employee. In this case, the employee may select (answer) a training which he/she think to have the highest relevance level to the work among the plurality of trainings whose relevance levels are equal to or higher than the threshold, presented by the transmitting unit 13.

The aforementioned answer data may include, for example, the usability level of the contents of the training for the work, the understanding level of the contents of the training, and the satisfaction level of the contents of the training. The usability level of the contents of the training for the work may be, for example, an index indicating how much the knowledge and skills learned in the training could be used for the work, subjectively evaluated by the employee.

The understanding level of the contents of the training may be, for example, an index indicating how much the employee understood the contents of the training, subjectively evaluated by the employee. Specifically, an answer may be obtained from choices such as “I understood the contents”, “I understood the contents to some degree”, “I did not understand the contents very well”, or “I did not understand the contents”. The satisfaction level of the contents of the training may be, for example, an index indicating the satisfaction level of the contents of the training, subjectively evaluated by the employee. Specifically, an answer may be obtained from choices such as “I was satisfied”, “I was satisfied to some extent”, “I was somewhat dissatisfied”, or “I was dissatisfied”.

The receiving unit 14 records data based on the answer data in the training evaluation DB 601. In the example shown in FIG. 6, in the training evaluation DB 601, for each training, the usability level of the contents of the training for the work, the understanding level of the contents of the training, and the satisfaction level of the contents of the training are recorded in association with a combination of a training ID and an employee ID. Note that in order to reduce the amount of feedback that the employee (user) needs to input, the answer may be simplified. For example, the apparatus or the system may be configured so that a plurality of trainings that might have been useful for the work are presented to the employee, and the employee is made (e.g., asked) to select one of them. In this case, detailed evaluations such as evaluations in regard to the understanding level and the satisfaction level are not made, and whether the training was useful for the work or not is simply evaluated.

Next, the determination unit 12 calculates the contribution level (usefulness level, effectiveness level, and contributing level) of the training to the work based on the relevance level determined in the process in the step S103 and the answer data received by the receiving unit 14 (Step S107). The contribution level may be, for example, an index indicating how much the training has contributed to the work. The determination unit 12 may determine the contribution level in such a manner that: the higher the relevance level is, the more the value of the contribution level is increased; and the higher the evaluation (at least one of the usability level of the contents of the training for the work, the understanding level of the contents of the training, and the satisfaction level of the contents of the training) made by the employee is, the more the value of the contribution level is increased.

Alternatively or additionally, the determination unit 12 may calculate the contribution level of the training to the work based on the progress of the work activities performed by the employee determined in the process in the step S102, the relevance level determined in the process in the step S103, and the answer data received by the receiving unit 14. In this case, the determination unit 12 may determine the contribution level in such a manner that: the faster the progressing level of work activities is, the more the value of the contribution level is increased; the higher the relevance level is, the more the value of the contribution level is increased; and the higher the evaluation (at least one of the usability level of the contents of the training for the work, the understanding level of the contents of the training, and the satisfaction level of the contents of the training) made by the employee is, the more the value of the contribution level is increased. Note that the progressing level of work activities may be, for example, the progress of work activities per unit time. Note that the process in the step S107 is not indispensable.

Note that the determination unit 12 may transmit a message recommending the participation of a training whose contribution level is equal to or higher than a threshold to, among one or more employees who have not participated in the training, an employee whose relevance level between the work activities and the training is equal to or higher than a threshold. In this way, it is possible to recommend an employee relevant to a specific work to participate in a training whose contribution level to the specific work is high.

In this case, the determination unit 12 may determine whether or not the contribution level calculated in the step S107 is equal to or higher than a threshold. Then, in a case where the contribution level is equal to or higher than the threshold, the determination unit 12 may refer to the employee DB 501 and extract an employee(s) who has not participated in the training. Then, the determination unit 12 may determine the relevance level between the work activities performed by the employee and the training based on the work log through a process similar to the process in the step S103. Then, the determination unit 12 may make, i.e., instruct, the transmitting unit 13 transmit a message recommending the participation of the training to the employee terminal 20 of the employee whose relevance level is equal to or higher than the threshold.

### Example of Use Case

An example of a use case where an employee acquires marketing skills by using the information processing apparatus 10 according to this example embodiment will be described hereinafter. For example, an employee assigned to a marketing department needs to acquire knowledge and skills relevant to marketing. Therefore, the employee accesses an in-house training management system and participates in a training relevant to marketing. In the training, the employee learns basic knowledge of marketing, techniques for market researches, and how to make a promotion strategy. The record of the participation in the training is automatically registered in the training management system (e.g., recorded in the training participation history stored in the employee DB 501).

The employee carries out actual work while using the knowledge learned in the training. For example, he/she plans a sales strategy for a new product and/or analyzes customer data. The collecting unit 11 collects PC operation logs of the employee, the schedule recorded in a schedule management system, and progress recorded in the work management system of the marketing department. From these data, the contents and progress of the marketing work performed by the employee are found.

Then, the determination unit 12 analyzes the collected work logs and the contents of the marketing training that the employee has participated. Specifically, keywords (e.g., market research, sales strategy, and promotion) contained in the work log are compared with keywords contained in the curriculum and textbook of the training, and the relevance level between them is calculated.

In a case where the relevance level between the work performed by the employee and the marketing training that the employee has participated is high (e.g., in a case where the relevance level is equal to or higher than a threshold), the transmitting unit 13 transmits a message for urging the employee to measure the effect of the training to his/her PC or smartphone.

The employee, who has received the message, answers a questionnaire for measuring the effect. In the questionnaire, it is asked how much the knowledge and skills learned in the training are used in the work, and the understanding level of the contents of the training and the satisfaction level thereof are asked.

The receiving unit 14 collects the results of the questionnaire answered by the employee and stores them in a storage unit (e.g., the training evaluation DB 601). Then, the determination unit 12 calculates the contribution level of the marketing training to the work by summarizing the result of the analysis of the relevance level and the result of the measurement of the effect. In a case where the relevance level is high and the satisfaction level and the understanding level in the measurement of the effect are high, it is evaluated that the contribution level of the training is high.

The calculated contribution level is taken into consideration in the training management system and a personnel evaluation system. In this way, the acquisition state of the marketing skill of the employee and the effect of the training are visualized. The manager of the employee analyzes a training whose contribution level is high and uses it for a training plan for subordinates. Further, a personnel department uses it to optimize a training program, for example, by allocating a large amount of budget to a training whose contribution level is high.

### (Example of Calculation of Contribution Level of Training Based on Outcome of Work Performed by Employee)

In the above-described example, an example in which the contribution level of a training to work is calculated based on the answer to a questionnaire by an employee has been described. An example in which the contribution level of a training to work is calculated based on, instead of or in addition to the answer to a questionnaire, the outcome of work registered by an employee will be described. According to the example described hereinafter, even if the employee inputs only the outcome of work, a training that has affected the outcome is automatically specified from among trainings that the employee participated in the past. Further, since the contribution level of the training is quantitatively calculated, the effect of the training on the employee himself/herself and on the whole organization can be visualized.

The collecting unit 11 may receive the outcome of the work input by the employee as a work log. Examples of outcomes may include reports, sales materials, programming codes, design drawings, product specifications, research papers, and patent specifications. The input form (data format) of outcomes may be any of various file formats such as a text file, a PDF (Portable Document Format), a presentation file, an image file, and a video file.

The determination unit 12 can recognize the contents of the work based on an outcome in a different file format. Specifically, the determination unit 12 may extract information about the contents of the work contained in the outcome by using a technology such as keyword extraction for text, a layout analysis and optical character recognition ((OCR: Optical Character Recognition) for a PDF, a slide image analysis and a document structure analysis for a presentation file, object recognition for an image, and motion recognition for a moving image.

The determination unit 12 may calculate a relevance level each time a work log is collected by the collecting unit 11. Further, the determination unit 12 may calculate the relevance level by collectively comparing a plurality of work logs input within a predetermined time with a training document. In this case, the determination unit 12 may calculate, for example, an average value or a maximum value of relevance levels between a training and individual work logs as the relevance level in the training. Further, the determination unit 12 may calculate the relevance level while regarding a plurality of work logs as one work log. Further, the determination unit 12 may receive information indicating that the input of a work log has been completed from the employee, and calculate the relevance level based on the work log that has been input before this information is received.

The determination unit 12 may compare, for a training whose relevance level exceeds a predetermined threshold, a work log before the employee participates in the training with a work log after he/she participates in the training, and estimate the contribution level based on the difference between them and the contents of the training. The work log before the employee participates in the training may be a work log before the training date, for example, the work log closest to the training date, or may consist of a plurality of work logs recorded over a period from a predetermined time before the training date to the training date.

The determination unit 12 may analyze a difference between keywords contained in the work log before the training and those after the training, and use, as an index of the contribution level, a rate at which a new keyword(s) that the employee must have learned during the training appears in the work log. Further, the determination unit 12 may also use the progressing level of the work, changes in productivity, and changes in the quality of the outcome for the calculation of the contribution level. Further, the determination unit 12 may take subjective answers of the employee (usability level, understanding level, satisfaction level, and the like) into consideration in the calculation of the contribution level.

### Modified Example

The information processing apparatus 10 may be an apparatus housed in one housing, but the information processing apparatus 10 according to the present disclosure is not limited to this example. Each component of the information processing apparatus 10 may be implemented by cloud computing composed of, for example, at least one computer. Further, the information processing apparatus 10 and the employee terminal 20 may be housed in one housing and configured as one integrated information processing apparatus. Further, at least some of the processes performed by the various functional units of the information processing apparatus 10 may be performed by the employee terminal 20. Such information processing apparatus 10 is also included in examples of an “information processing apparatus” according to the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

The whole or part of the example embodiments disclosed above can be described as, but not limited to, the following supplementary notes. Some or all of the elements (e.g., structures and functions) described in any of supplementary notes dependent on Supplementary note 1 can be dependent on any of independent supplementary notes in other categories by the same dependency relationships. Some or all of the elements described in any of the supplementary notes can be applied to various types of hardware, software, recording means for recording software, systems, and methods.

### (Supplementary Note 1)

An information processing apparatus comprising:
collecting means for collecting a work log related to a work activity performed by an employee;
determination means for determining a relevance level between the work log and a training that the employee has participated;
transmitting means for transmitting a question for evaluating the training to the employee in a case where the relevance level is equal to or higher than a threshold; and
receiving means for receiving answer data of the employee to the question.

### (Supplementary Note 2)

The information processing apparatus described in Supplementary note 1, wherein the determination means calculates a contribution level of the training to work based on the relevance level and the answer data received by the receiving means.

### (Supplementary Note 3)

The information processing apparatus described in Supplementary note 2, wherein the determination means determines progress of the work activity performed by the employee based on the work log, and calculates the contribution level of the training to the work based on the progress, the relevance level, and the answer data received by the receiving means.

### (Supplementary Note 4)

The information processing apparatus described in Supplementary note 2 or 3, wherein in a case where the contribution level is equal to or higher than a threshold, the transmitting means transmits a message recommending participation in the training to, among one or more employee who have not participated in the training, an employee whose relevance level between the work activity performed by the employee and the training is equal to or higher than a threshold.

### (Supplementary Note 5)

The information processing apparatus described in Supplementary note 1 or 2, wherein the work log includes at least one of an operation log of an apparatus used by the employee in the work activity, a usage state of a meeting room by the employee, progress of work performed by the employee, a video image of work performed by the employee, a content of a document created by the employee, and data measured by a sensor.

### (Supplementary Note 6)

The information processing apparatus described in Supplementary note 1 or 2, wherein the determination means calculates the relevance level based on at least one of a commonality level between a keyword contained in the work log and a keyword contained in a document of the training, and a similarity level therebetween.

### (Supplementary Note 7)

The information processing apparatus described in Supplementary note 1 or 2, wherein
the transmitting means presents, to the employee, a plurality of trainings whose relevance levels are equal to or higher than a threshold, and
the receiving means receives a result of a choice among the plurality of trainings made by the employee.

### (Supplementary Note 8)

The information processing apparatus described in Supplementary note 1 or 2, wherein the determination means determines the relevance level by using at least one of a topic analysis, a document vector, supervised learning, a network analysis, and a time-series analysis.

### (Supplementary Note 9)

The information processing apparatus described in Supplementary note 1 or 2, wherein the answer data includes at least one of a usability level of a content of the training to work, an understanding level of the content of the training, and a satisfaction level of the content of the training.

### (Supplementary Note 10)

An information processing method, wherein an information processing apparatus:
collects a work log related to a work activity performed by an employee;
determines a relevance level between the work log and a training that the employee has participated;
transmits a question for evaluating the training to the employee in a case where the relevance level is equal to or higher than a threshold; and
receives answer data of the employee to the question.

### (Supplementary Note 11)

A non-transitory computer readable medium storing a program for causing a computer to:
collect a work log related to a work activity performed by an employee;
determine a relevance level between the work log and a training that the employee has participated;
transmit a question for evaluating the training to the employee in a case where the relevance level is equal to or higher than a threshold; and
receive answer data of the employee to the question.

What is claimed is:

1. An information processing apparatus comprising:
at least one memory storing instructions; and
at least one processor configured to execute the instructions to:
collect a work log related to a work activity performed by an employee;
determine a relevance level between the work log and a training participated in by the employee;
transmit a question for evaluating the training to the employee based on a comparison of the relevance level with a threshold; and
receive answer data of the employee to the question.

2. The information processing apparatus according to claim 1, wherein the processor is further configured to execute the instructions to calculate a contribution level of the training to work based on the relevance level and the received answer data.

3. The information processing apparatus according to claim 2, wherein the processor is further configured to execute the instructions to determine progress of the work activity performed by the employee based on the work log, and calculate the contribution level of the training to the work based on the progress, the relevance level, and the received answer data.

4. The information processing apparatus according to claim 2, wherein the processor is further configured to execute the instructions to, in a case where the contribution level is equal to or higher than a threshold, transmit a message recommending participation in the training to, among one or more employee who have not participated in the training, an employee whose relevance level between the work activity performed by the employee and the training is equal to or higher than a threshold.

5. The information processing apparatus according to claim 1, wherein the work log includes at least one of an operation log of an apparatus used by the employee in the work activity, a usage state of a meeting room by the employee, progress of work performed by the employee, a video image of work performed by the employee, a content of a document created by the employee, and data measured by a sensor.

6. The information processing apparatus according to claim 1, wherein the processor is further configured to execute the instructions to calculate the relevance level based on at least one of a commonality level between a keyword contained in the work log and a keyword contained in a document of the training, and a similarity level therebetween.

7. The information processing apparatus according to claim 1, wherein the processor is further configured to execute the instructions to:
present, to the employee, a plurality of trainings whose relevance levels are equal to or higher than a threshold; and
receive a result of a choice among the plurality of trainings made by the employee.

8. The information processing apparatus according to claim 1, wherein the processor is further configured to execute the instructions to determine the relevance level by using at least one of a topic analysis, a document vector, supervised learning, a network analysis, and a time-series analysis.

9. The information processing apparatus according to claim 1, wherein the answer data includes at least one of a usability level of a content of the training to work, an understanding level of the content of the training, and a satisfaction level of the content of the training.

10. An information processing method, wherein an information processing apparatus:
collects a work log related to a work activity performed by an employee;
determines a relevance level between the work log and a training participated in by the employee;
transmits a question for evaluating the training to the employee based on a comparison of the relevance level with a threshold; and
receives answer data of the employee to the question.

11. A non-transitory computer readable medium storing a program for causing a computer to:
collect a work log related to a work activity performed by an employee;
determine a relevance level between the work log and a training participated in by the employee;
transmit a question for evaluating the training to the employee based on a comparison of the relevance level with a threshold; and
receive answer data of the employee to the question.
